(19) United States
(12) Patent Application Publication
(10) Pub. No.: US 2007/0127832 A1
(43) Pub. Date: Jun. 7, 2007

(54) Device for controlling the representation of information

(75) Inventors: Markus Baumann, Stuttgart (DE); Carla Knoop, Stuttgart (DE); Jochen Moritz, Ingolstadt (DE); Armin Zachay, Rechberghausen (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, STUTTGART (DE)

(21) Appl. No.: 10/576,082

(22) PCT Filed: Sep. 11, 2004
(86) PCT No.: PCT/EP04/10184

§ 371 Date: Dec. 19, 2006

(30) Foreign Application Priority Data
Oct. 14, 2003 (DE) 103 47 562.1

(51) Int. Cl. G06K 9/46

(52) U.S. Cl. 382/243

(57) ABSTRACT

A device for controlling the representation of information on a vehicle screen includes an actuator which can be rotated about a longitudinal axis and deflected transversely with respect to the longitudinal axis. The portion (2) of the information which is represented on the vehicle screen displaced by a deflection movement of the actuator transversely with respect to the longitudinal axis (z), and discrete markable elements can be marked by a rotational movement of the actuator about the longitudinal axis. The information includes the discrete markable elements.

### BACKGROUND AND SUMMARY OF THE INVENTION

The invention relates to a device for controlling the representation of information on a vehicle screen.

German Patent Document DE 198 37 510 A1 discloses a device for controlling the representation of an image on a vehicle screen. The device can be operated by an actuator which can be rotated about a longitudinal axis and can be deflected transversely with respect to the longitudinal axis. In the portion of the image which is represented on the screen there is a box which is displaced by means of a transverse deflection of the actuator. The scale of the portion of the image which is located in the box is changed by rotating the actuator about the longitudinal axis.

The present invention is based on the object of making available a device for controlling the representation of information on a vehicle screen, which device can be operated easily and intuitively.

The representation of information on a vehicle screen requires both a clear layout of the information and ease of operation when marking information. In particular discrete markable elements such as occur, for example, on Internet pages require operator control options which are adapted to the conditions in the motor vehicle. The invention permits simple selection of a portion of the information represented on the vehicle screen. The invention also permits easy and convenient marking of elements. Both the selection of the portion and the marking can be carried out here in an intuitive way using a single actuator.

The invention permits the portion which is represented on the motor vehicle screen to be displaced vertically and horizontally in an intuitive way by displacing the portion in the same direction as that in which the actuator is moved by the user. This is particularly advantageous if the information cannot be displayed completely on the vehicle screen as is the case, for example, with Internet pages or maps for navigation systems. If the portion is in a final position, it is not moved further even when the actuator is moved. This makes it possible to implement a type of stop.

The marking of discrete markable elements is also possible in an intuitive way by rotating the actuator. In this way, in each case the discrete markable element which is closest in the direction of rotation is marked. Particularly simple and intuitive operator control is made possible by the correspondence between the direction of rotation and the direction in which the next marking occurs. If there is no further discrete markable element in the direction of rotation, the element which has already been marked stays marked even if the actuator is rotated. In this way it is possible to implement a type of stop.

In one advantageous embodiment of the invention, the information is Internet pages. Internet pages are received, for example, from outside the vehicle, for example from a service provider by mobile radio. The Internet pages are produced here by the service provider for a large number of different devices with differing equipment levels. It is therefore possible for the Internet page to be larger in its scope than the portion which can be represented on the vehicle screen. The advantageous embodiment of the invention permits simple and convenient operator control of Internet pages in the vehicle.

In one advantageous embodiment of the invention, the device controls the representation of messages. The represented information comprises here, for example, headers such as sender, receiver, subject matter as well as the message content. Discrete markable elements comprise, for example, addresses, telephone numbers, Internet addresses, Uniform Resource Locator (URL), and/or geocodes. The discrete markable elements are marked, for example, by representation in a different color and/or with a different background. When an element is selected it is then advantageous to represent a menu on the screen which provides the user with the possible actions which can be carried out by using the selected element. If the selected element is, for example, a telephone number it would be possible to provide it to the user to set up a telephone connection to this number and/or to transfer the telephone number to an address book.

Further examples of information which can be represented are lists, in particular lists with selectable list elements and/or representations of maps. The representations of maps may be, for example, representations of maps of a navigation system, and the markable discrete elements of the map may be objects which are offered to the user as navigation destinations by the navigation system and can be marked by the user. This is particularly advantageous if, for example, destinations of a specific category are offered to the user by the navigation system, for example all the multistory car parks in the surroundings. The user can then mark the destination and, by selecting it, transfer it to the navigation system as a destination of a routing operation.

The marking of the discrete markable elements is carried out by rotating the actuator about its longitudinal axis. Rotating in the clockwise direction marks the next element and rotating in the counterclockwise direction marks the previous element. The marked element is represented on the screen by, for example, a representation in a different color and/or with a different background than the other, non-marked discrete markable elements and than the other information.

The discrete markable elements are selected by activating the actuator in the direction of its longitudinal axis, for example by pressing the actuator. When an element is selected, an action is carried out using the element. The action can depend on the type of discrete markable element. The action can comprise, for example, the representation of the element on the screen; this is advantageous, for example, if the element comprises a reference to a further page or to an image. The action may comprise, for example, the representation of a selection list. The entries in the selection list then advantageously depend on the selected element and provide the user with options as to which further actions are carried out using the selected element. By selecting a list element in the selection list, the user can then trigger such a further action.

In one advantageous embodiment of the invention, the displacement of the portion which is represented on the screen can also be carried out by rotating the actuator about the longitudinal axis. The selection of discrete markable elements can optionally also be carried out by deflecting the actuator transversely with respect to the longitudinal axis.

### BRIEF DESCRIPTION OF THE DRAWINGS

FIG. 1 shows a page 4 with information which is to be represented, with discrete markable elements 6 and a portion 2 represented on the screen in a first final position,

FIG. 2 shows a page 4 with information which is to be represented and a portion 2 which is represented on the screen in a second final position,

FIG. 3 shows a page 4 with information to be represented and a portion 2 which is represented on the screen in a third final position,

FIG. 4 shows a page 4 with information which is to be represented and a portion 2 which is represented on the screen in a fourth final position,

FIG. 5 shows a page 4 with information which is to be represented and a portion 2 which is represented on the screen in an intermediate position,

FIG. 6 shows pages 4 with information which is to be represented, a portion 2 which is represented on the screen and a marked discrete markable element,

FIG. 7 shows an exemplary embodiment of the control of the representation of pages,

FIG. 8 shows an exemplary embodiment of the control of the representation of pages,

FIG. 9 shows an exemplary embodiment of the control of the representation of messages,

FIG. 10 shows an exemplary embodiment of the control of the representation of messages,

FIG. 11 shows an actuator (120) with a plurality of different degrees of freedom of adjustment.

### DETAILED DESCRIPTION OF THE DRAWINGS

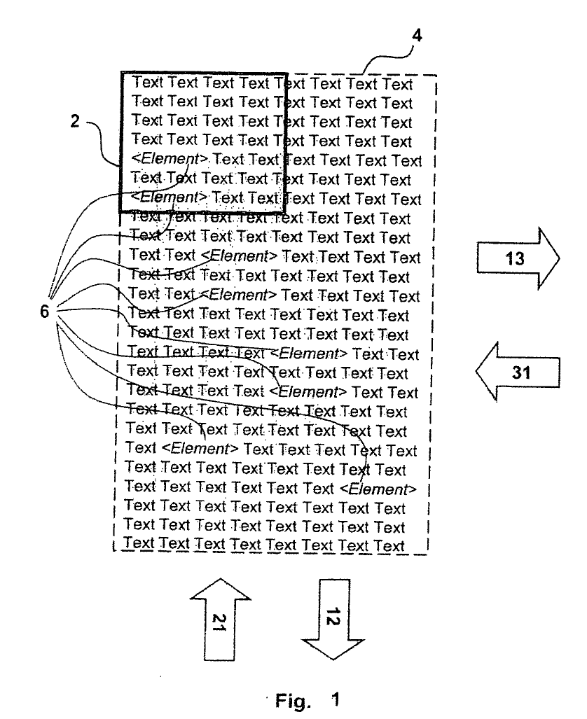

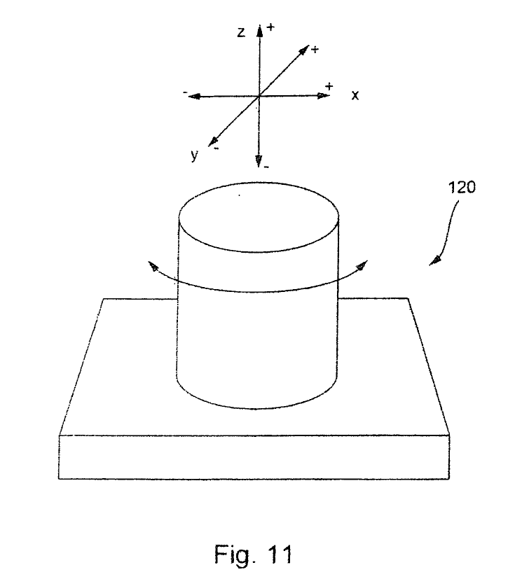

FIG. 1 represents a page 4 with information to be represented. The portion 2 which is represented on the vehicle screen is located in a first final position in the top left corner of the page. The information comprises discrete markable elements 6. The portion 2 is displaced by moving the actuator 120, shown in FIG. 11 transversely with respect to the longitudinal axis z. Moving the actuator 120 to the right, in the positive x direction, displaces the portion 2 of information to the right. Moving the actuator 120 downward, in the negative y direction, displaces the portion 2 of information downward.

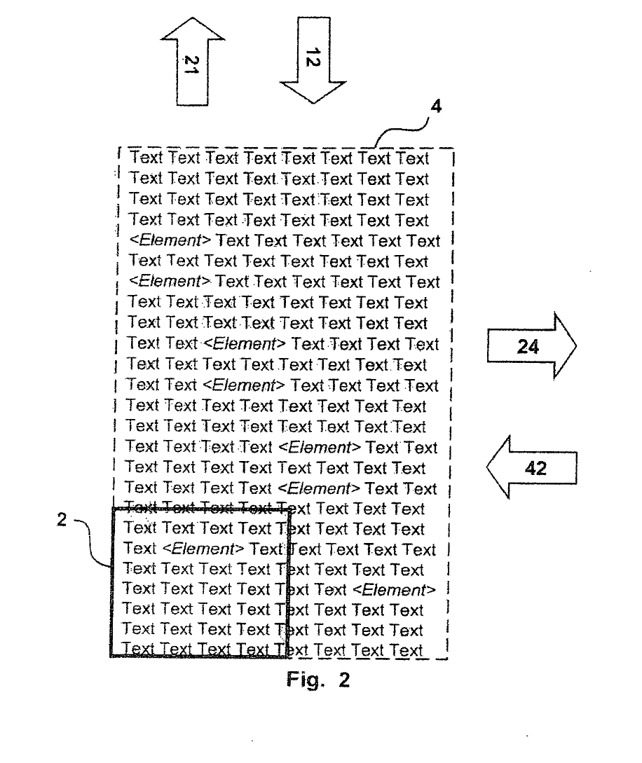

FIG. 2 represents a portion 2 of information on the vehicle screen which is located at the bottom left edge of the page 4. The portion 2 is located in a second final position. The operator control step 12 therefore moves the portion from the first final position in FIG. 1 to the second final position in FIG. 2. The operator control step 12 includes a single movement, or multiple movement, of the actuator 120 transversely downward with respect to the longitudinal axis z, in the negative y direction. The operator control step 21 moves the portion from the second final position represented in FIG. 2 to the first final position represented in FIG. 1. The operator control step 21 comprises here a single movement, or multiple movement, of the actuator 120 transversely upward with respect to the longitudinal axis z, in the positive y direction.

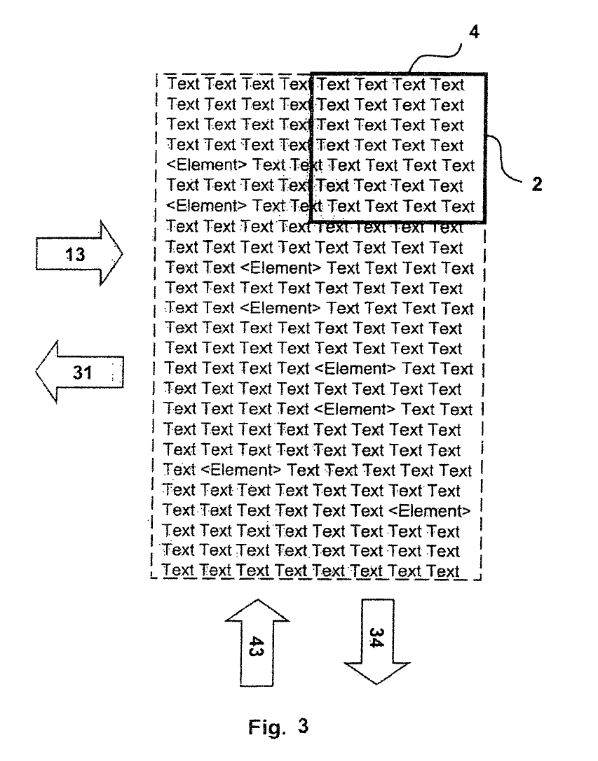

In the illustration in FIG. 3, the portion 2 is located in a third final position in the top right corner of the page 4. The operator control step 13 therefore moves the portion from the first final position in FIG. 1 to the third final position in FIG. 3. The operator control step 13 comprises here a single movement, or multiple movement, of the actuator 120 transversely to the right with respect to the longitudinal axis z, in the positive x direction. The operator control step 31 moves the portion from the third final position represented in FIG. 3 to the first final position represented in FIG. 1. The operator control step 31 includes a single movement, or multiple movement, of the actuator 120 transversely to the left with respect to the longitudinal axis z, in the negative x direction.

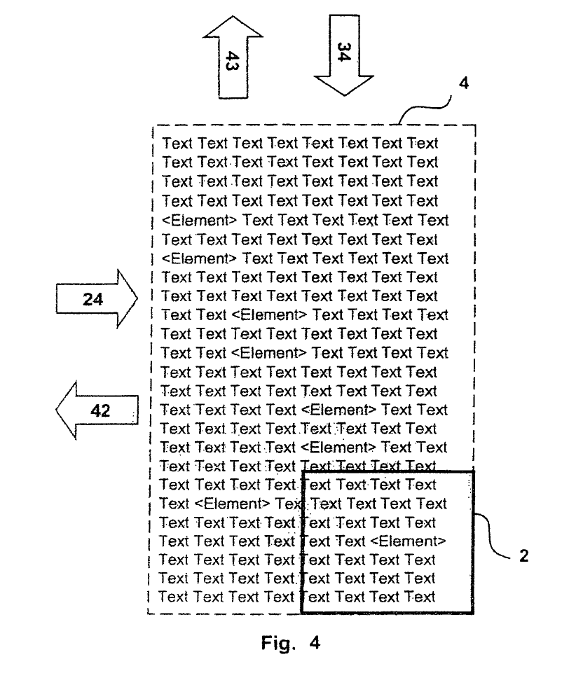

A fourth final position of the portion 2 is represented in FIG. 4. Here, the portion of information which is represented on the vehicle screen is located in the bottom right corner of the page 4. Moving the actuator 120 to the left, in the negative x direction, displaces the portion 2 of information to the left. Moving the actuator 120 upward, in the positive upward y direction, displaces the portion 2 of information.

The operator control step 24 moves the portion from the second final position in FIG. 2 to the fourth final position in FIG. 4. The operator control step 24 comprises here a single movement, or multiple movement, of the actuator 120 transversely to the right with respect to the longitudinal axis z, in the positive x direction. The operator control step 42 moves the portion from the fourth final position which is represented in FIG. 4 to the second final position which is represented in FIG. 2. The operator control step 42 includes a single movement, or multiple movement, of the actuator 120 transversely to the left with respect to the longitudinal axis z, in the negative x direction.

The operator control step 34 moves the portion from the third final position in FIG. 3 to the fourth final position in FIG. 4. The operator control step 34 comprises here a single movement, or multiple movement, of the actuator 120 transversely downward with respect to the longitudinal axis z, in the negative y direction. The operator control step 43 moves the portion from the fourth final position represented in FIG. 4 to the third final position represented in FIG. 3. The operator control step 43 includes a single movement, or multiple movement, of the actuator 120 transversely upward with respect to the longitudinal axis z, in the positive y direction.

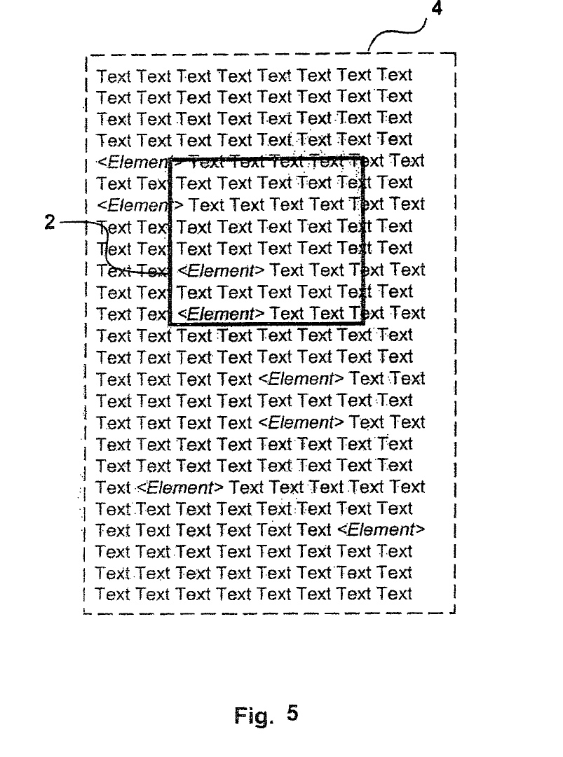

FIG. 1, FIG. 2, FIG. 3, and FIG. 4 each represent the portion 2 in a final position. Of course, any desired portions 2 of the page 4 can be represented on the vehicle screen. Such an intermediate position is represented in FIG. 5 by way of example. Any desired intermediate positions of the portion 2 can be reached by moving the actuator 120 transversely with respect to the longitudinal axis z.

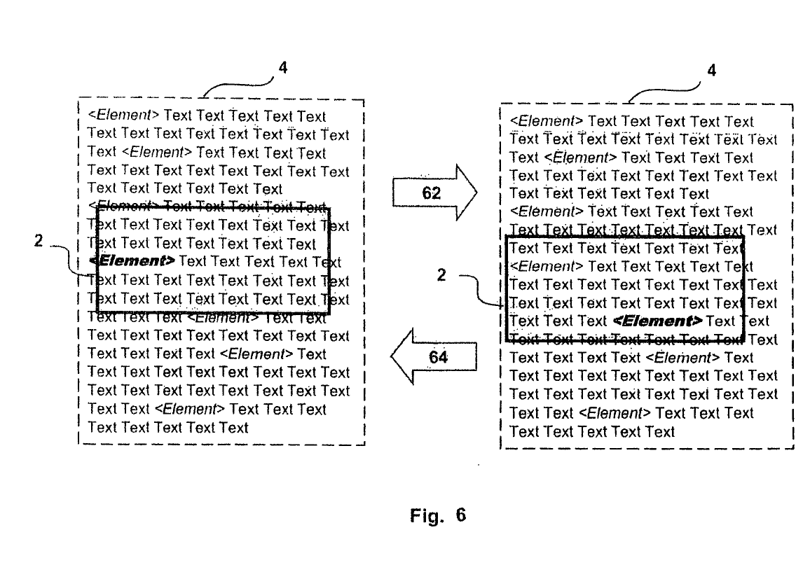

FIG. 6 represents a page 4 of information. In the representation in the left half of the image, a first element is marked. In the representation in the right half of the image a second element is marked which differs from the first element. The marked element is represented on the vehicle screen—it is located in the portion 2. The operator control step 62 moves the portion from the representation in the left half of the image in FIG. 6 to the representation in the right half of the image in FIG. 6. The operator control step 62 comprises rotating the actuator 120 about the longitudinal axis z in the clockwise direction. By rotating in the clockwise direction, the next discrete markable element in the reading direction is marked. If the new marked element lies outside the portion 2 which is represented on the vehicle screen, the portion is displaced in such a way that the marked element appears in the portion 2. The operator control step 64 comprises rotating the actuator 120 about the longitudinal axis z in the counterclockwise direction. As a result, the previous discrete markable element in the reading direction is marked. This corresponds to the transition from the representation in the right half of the image in FIG. 6 to the representation in the left half of the image in FIG. 6.

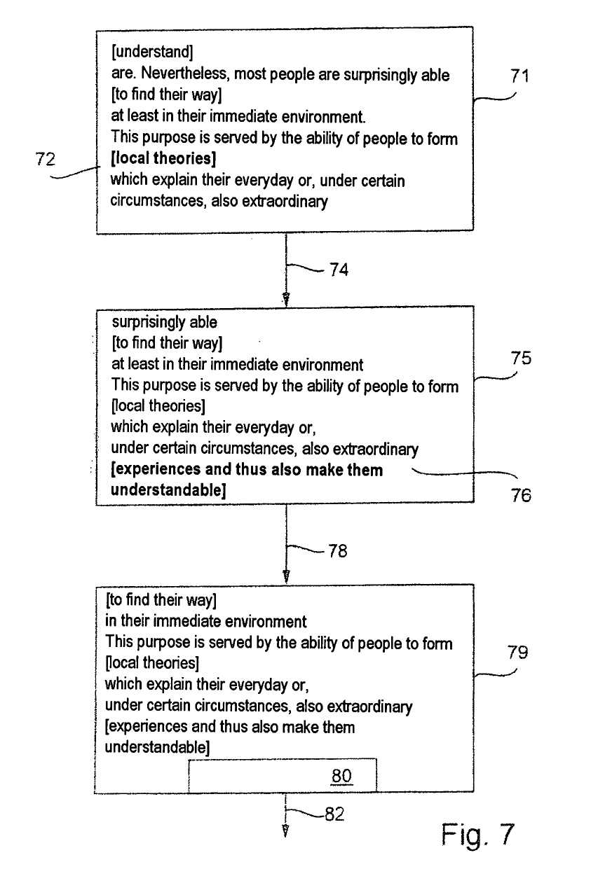

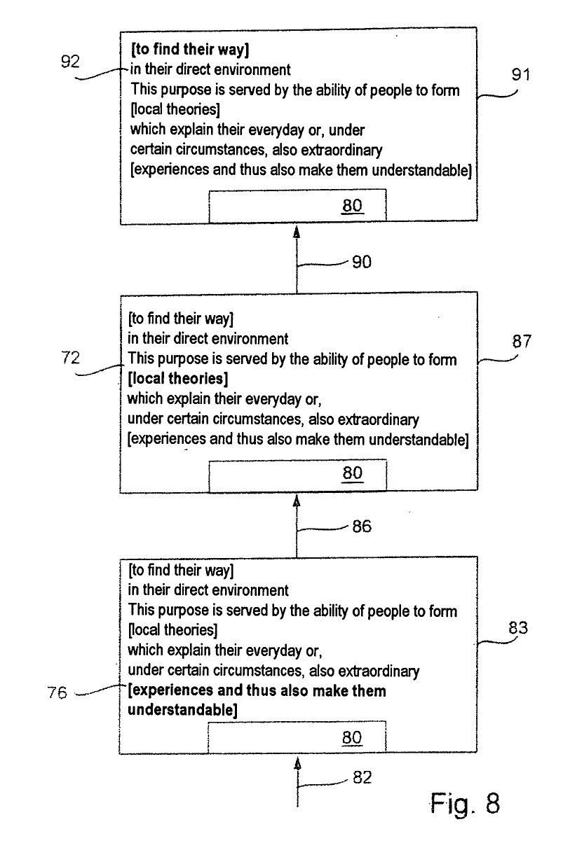

FIG. 7 and FIG. 8 represent by way of example the control of the representation of information, the information being present in a lateral representation and comprising, as discrete markable elements, references to further pages and/or images. In the portion 71 represented on the vehicle screen, the discrete markable element 72 is marked, as represented in FIG. 7. By rotating the actuator 120 in the clockwise direction in operator control step 74, the transition to portion 75, in which the discrete markable element 76 is represented in a marked form, is brought about. Step 78 brings about the transition to the representation in portion 79. Step 78 selects the element 80, which comprises a reference to an image, by once more rotating the actuator 120 in the clockwise direction. By rotating the element 120 in the counterclockwise direction in operator control step 82, the transition to the representation in portion 83 is brought about, in which portion 83 the discrete markable element 76 is again represented in a marked form. The transition to portion 87 in step 86 is brought about in an analogous fashion by rotating the actuator in the counterclockwise direction so that element 72 is again marked. Step 90 brings about the representation in portion 91, in which the element 92 is marked, by rotating the actuator 120 in the counterclockwise direction.

By rotating the actuator 120 in the clockwise direction, the next element is therefore marked. By rotating the actuator 120 in the counterclockwise direction, the preceding element is marked. If the next element which is to be represented in a marked form cannot be seen in the portion which is represented on the vehicle screen, the portion is therefore displaced onto the information to be represented until the element which is to be represented in a marked form is completely visible in the portion. The displacement of the portion onto the information to be represented is advantageously carried out line by line here. If the element which is to be represented in a marked form is an image, the portion is displaced until part of the image is represented, the part of the image being at least one line high and approximately one letter wide.

In FIG. 7 and FIG. 8, the portion of the image can be additionally displaced by moving the actuator 120. This is done in an analogous fashion to the control described with reference to FIG. 1 to FIG. 5.

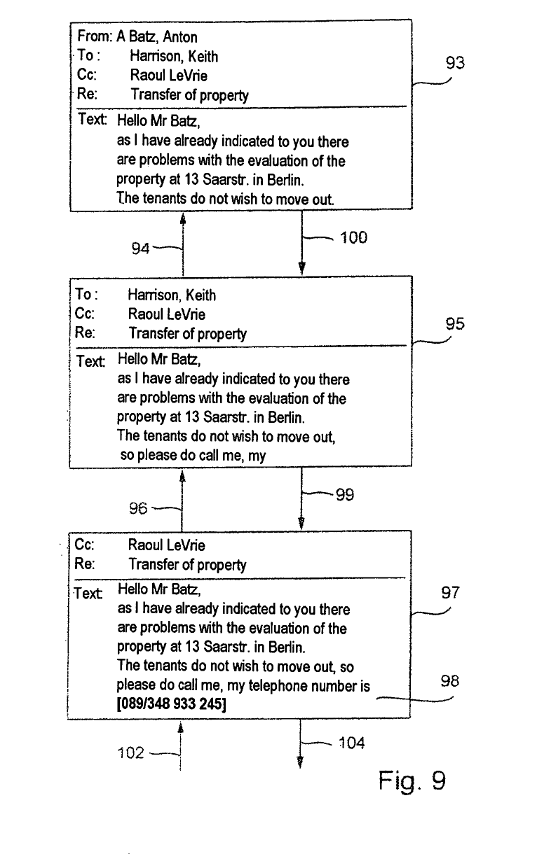

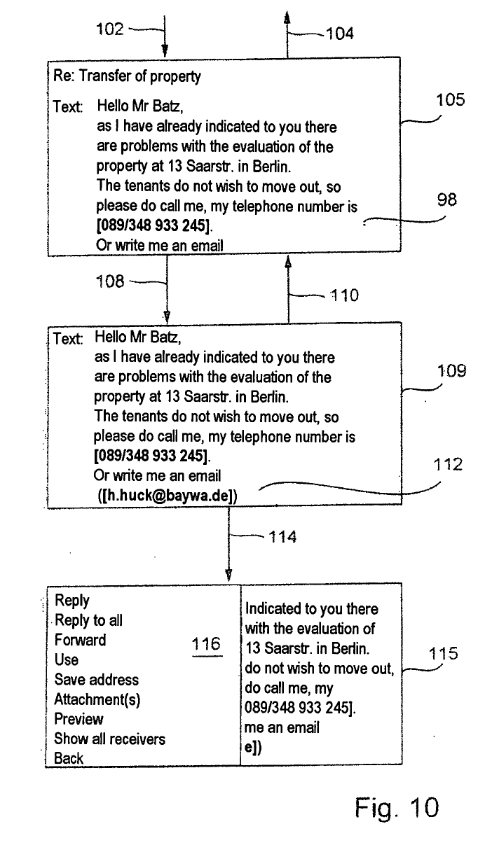

The control of the representation of messages is represented by way of example in FIG. 9 and FIG. 10, the messages having telephone numbers and/or e-mail addresses as discrete markable elements. By way of example, a portion of a message comprising sender information, receiver information, subject matter line and message text is represented in the portion 93. The operator control step 94 brings about the representation in portion 95 in which the represented portion 95 has been displaced one line downward with respect to the represented portion 93 so that in portion 95 one line more of the message text is represented, and as a result no transmitter information is represented any more. The operator control step 94 can comprise moving the actuator downward or rotating the actuator in the clockwise direction here. Starting from portion 95, the operator control step 100—moving the actuator 120 upward or rotating the actuator in the counterclockwise direction—brings about the representation in portion 93 in which the represented portion 93 has been displaced upward by one line compared to portion 95.

The transition from portion 95 to portion 97 is carried out by means of step 96 and the transition from portion 97 to portion 95 is carried out by means of step 99, in a way which is analogous to step 94. Step 96 includes moving the actuator 120 downward or rotating the actuator 120 in the clockwise direction. Step 99 includes moving the actuator 120 upward or rotating the actuator 120 in the counterclockwise direction here.

By rotating the actuator 120 in the clockwise direction in step 96, at the same time the discrete markable element 98 which appears at the lower edge of the portion 97 is marked. If the element 98 is marked and if the actuator 120 is rotated further in the clockwise direction in step 102, the portion 97 is displaced one line downward so that the representation according to portion 98 is brought about. Further rotating the actuator 120 in the clockwise direction in step 108 brings about the representation in portion 109 in which the discrete markable element 112 in the last line of the portion 109 is marked. Moving the actuator 120 downward in the steps 96 or 108 brings about the representations in portions 97 and 109 respectively, but does not bring about marking of the elements 98 or 112.

Discrete markable elements comprise, for example, e-mail addresses, addresses, telephone numbers, Uniform Resource Locators (URL) and/or geocodes.

The steps 104, 110 analogously comprise rotating the actuator 120 in the counterclockwise direction or moving the actuator 120 upward. By rotating the actuator, the respective previous discrete markable element is marked, and if there is no previous discrete markable element visible in the portion, the portion is displaced one line upward. This brings about the representation in the portions 109, 105 and 97.

In step 114, the actuator is pressed in the direction of the longitudinal axis z starting from the representation in portion 109. The representation in portion 115 follows, where region 116 with a list is represented inside the portion 115. Possible actions which can be carried out with the message are specified in the list. It is possible to provide that the same list is always displayed when the actuator 120 is pressed. The list can then also optionally be displayed irrespective of whether or not an element is marked.

In one advantageous exemplary embodiment (not illustrated) of the invention, a list which provides the user with options as to how the selected element can be used is displayed starting, for example, from portion 109, by selecting a marked discrete markable element in a region of the represented portion. It is possible, for example, to provide in the list the option of setting up a telephone link to the selected element.

FIG. 11 illustrates an actuator 120 of the device for controlling the representation of information. The actuator 120 can be deflected transversely with respect to the longitudinal axis z, in any desired directions, for example x direction or y direction, or in a combination of the x direction and y direction. The actuator 120 can be moved further in the direction of the longitudinal axis z. This movement can occur in both directions of the z axis.

In one preferred embodiment of the invention, the deflection occurs transversely with respect to the longitudinal axis z in the form of a displacement transversely with respect to the longitudinal axis z. In this context it is advantageous, for example, to restrict the movement transversely with respect to the longitudinal axis z to, for example, four directions—positive x direction, negative x direction, positive y direction, negative y direction. The restriction to eight directions is particularly advantageous for the representation of Internet pages and/or messages. Alternatively, the movement transversely with respect to the longitudinal axis z can be restricted to, for example, eight directions—positive x direction, 45° direction between the positive x and y directions, positive y direction, 45° direction between the negative x direction and positive y direction, negative x direction, 45° direction between the negative x and y directions, negative y direction, 45° direction between the positive x direction and negative y direction. The restriction to eight directions is particularly advantageous for representing maps, for example for a navigation system.

1-9. (canceled)

10. A device for controlling the representation of information on a vehicle screen, comprising an actuator about a longitudinal axis (z) and movable transversely with respect to the longitudinal axis (z), wherein a portion of the information is represented on the vehicle screen and is displaced by a deflection movement of the actuator transversely with respect to the longitudinal axis z, and wherein discrete markable elements can be marked by a rotational movement of the actuator about the longitudinal axis (z), wherein the information comprises the discrete markable elements.

11. The device as claimed in claim 10, wherein each one of the marked discrete markable elements is selected by moving the actuator axially with respect to the longitudinal axis (z).

12. The device as claimed in claim 10, wherein the information is provided in a lateral representation, wherein the portion of the page represented on the vehicle screen is smaller than a page size.

13. The device as claimed in claim 12, wherein finished pages are received from outside the vehicle via a communications device and can be represented on the vehicle screen.

14. The device as claimed in claim 13, characterized in that the finished pages are Internet pages.

15. The device as claimed in one of claim 13, wherein each one of the discrete markable elements comprises a reference to one of at least one further page and at least one image.

16. The device as claimed in claim 15, wherein selection of the reference represents the said one of at least one further page and at least one image on the vehicle screen.

17. The device as claimed in claim 10, wherein the information are messages which are received from outside the vehicle.

18. The device as claimed in claim 10, wherein each one of the discrete markable element comprises a telephone number or an address.

19. The device as claimed in claim 11, wherein the information is provided in a lateral representation, wherein the portion of the page represented on the vehicle screen is smaller than a page size.

20. The device as claimed in one of claims 13, wherein each one of the discrete markable elements comprises a reference to one of at least one further page and at least one image.

21. The device as claimed in one of claims 14, wherein each one of the discrete markable elements comprises a reference to one of at least one further page and at least one image.

22. The device as claimed in claim 11, wherein the information are messages which are received from outside the vehicle.
